(19) United States
(12) Patent Application Publication
(10) Pub. No.: US 2009/0130447 A1
(43) Pub. Date: May 21, 2009

(54) Hydrophilic systems and methods thereof

(75) Inventor: Michael D. Potter, Churchville, NY (US)

Correspondence Address: NIXON PEABODY LLP - PATENT GROUP, 1100 CLINTON SQUARE, ROCHESTER, NY, 14604, US

(73) Assignee: Nth Tech Corporation, Churchville, NY (US)

(21) Appl. No.: 12/291,944

(22) Filed: Nov. 14, 2008

Related U.S. Application Data
(60) Provisional application No. 60/988,544, filed on Nov. 16, 2007.

(51) Int. Cl. B32B 9/00

(52) U.S. Cl. 428/408; 428/446; 428/696; 428/699; 428/701

(57) ABSTRACT

A hydrophilic system and method includes a substrate selected because of at least one designated optical property and one or more dissimilar insulating layers. The one or more dissimilar insulating layers are one of on and adjacent to at least a portion of a surface of the substrate and optically operate without substantial interference of the at least one designated optical property of the substrate. A substantially fixed and static monopole electrical charge is embedded at an interface between at least one of the substrate and one of the one or more dissimilar insulating layers and two of the one or more dissimilar insulating layers.

This application claims the benefit of U.S. Provisional Patent Application Ser. No. 60/988,544, filed Nov. 16, 2007, which is herein incorporated by reference in its entirety.

### FIELD OF THE INVENTION

The present invention generally relates to hydrophilic systems and methods and, more particularly, to embedded electron charge hydrophilic systems and methods thereof.

### BACKGROUND

Traditionally, the human body is thought to have five senses: sight; hearing; touch; smell; and taste. With respect to these five senses, sight provides the most information and thus protection of this sense is of utmost importance. Unfortunately, apparatuses which are associated with the use of this sense, such as face shields, goggles, visors, windshields, windows, etc., are all subject to fogging, thereby reducing or virtually eliminating visual surveillance of the immediate environment and any potential hazard or danger.

Any material that has a temperature below the dew point of the environment will experience condensation on the material surface. If the surface is a hydrophobic material, the condensation is in the form of droplets of varying size. These droplets scatter light, i.e., the surface fogs up, which reduces visibility. Anyone who wears glasses and enters a warm building from a cold outside environment, such as on a cold winter day, has experienced fogging.

One technique to change a hydrophobic surface to a hydrophilic surface is by electro-wetting. Electro-wetting is achieved by applying an electric field between two electrodes buried within normally hydrophobic materials. Strong electro-wetting has been demonstrated by applying −20V to a water filled capacitor type structure with a 50 micron plate spacing. This equates to less than 2×10¹¹ charges/cm² (assuming DI water and using a relative dielectric constant (∈ᵢ) of 84). Prior art electro-wetting requires two or more electrodes and therefore is difficult to use as a means to convert a transparent material such as a visor, goggles, windshield, etc. to an anti-fogging hydrophilic surface. Using high electric fields and metal-insulator-semiconductor capacitors, permanently stored, electron charged, nano layers with charge levels of greater than 1×10¹³ e⁻/cm² have been demonstrated. Since a much lower charge density is all that is required, the proper charge density can be established dependent on the application. It also has been shown that electro-wetting is polarity independent. By way of example, side views of prior art electro-wetting as a function of applied voltages of 10V, 30V, 40V, 50V, 60V, and 70V for a given structure are illustrated in FIG. 1.

The conversion from a hydrophobic material to a hydrophilic material with this prior art electro-wetting also is illustrated in FIGS. 2A and 2B. First, a droplet of water on a hydrophobic material without a voltage applied to electrodes, one electrode is a wire into the top of the droplet and one electrode is buried in the hydrophobic material is illustrated in FIG. 2A. Next, when a voltage is applied to these electrodes, the hydrophobic material becomes a hydrophilic material and the water molecules in the droplet line up in such a way as to wet the surface as shown in FIG. 2B.

### SUMMARY

An hydrophilic system in accordance with embodiments of the present invention includes a substrate selected because of at least one designated optical property and one or more dissimilar insulating layers. The one or more dissimilar insulating layers are one of on and adjacent to at least a portion of a surface of the substrate and optically operate without substantially interference of the at least one designated optical property of the substrate. A substantially fixed and static monopole electrical charge is embedded at an interface between at least one of the substrate and one of the one or more dissimilar insulating layers and two of the one or more dissimilar insulating layers.

A method of making a hydrophilic system in accordance with other embodiments of the present invention includes selecting a substrate because of at least one designated optical property. One or more dissimilar insulating layers are provided which are one of on and adjacent to at least a portion of a surface of the substrate and which operate without substantially interference of the at least one designated optical property of the substrate. A substantially fixed and static monopole electrical charge is embedded at an interface between at least one of the substrate and one of the one or more dissimilar insulating layers and two of the one or more dissimilar insulating layers.

The present invention provides an effective and easy to implement hydrophilic system. Unlike any prior surface treatment or coating, the present invention will virtually never wear out and the effectiveness of the present invention is never lost or reduced in effectiveness during any cleaning or wiping whatsoever. The present invention remains hydrophilic even with a wax coating.

Additionally, the present invention can be manufactured using conventional industry standard thin film deposition processes. As a result, the present invention is inexpensive to produce for both the military and other commercial markets.

### BRIEF DESCRIPTION OF THE DRAWINGS

FIG. 1 is a side view prior art electro-wetting as a function of applied voltages of 10V, 30V, 40V, 50V, 60V, and 70V for a given structure;

FIGS. 2A and 2B are side, cross-sectional views of a water droplet on a prior art hydrophobic surface with one buried electrode and a top immersed electrode without and with an applied electrical bias;

FIG. 3 is a side, cross-sectional view of an hydrophilic system in accordance with embodiments of the present invention;

FIG. 4 is a side, cross-sectional view of another hydrophilic system in accordance with other embodiments of the present invention;

FIG. 5A is a side, cross-sectional view of a water droplet on a prior art hydrophobic surface;

FIG. 5B is a side, cross-sectional view of plurality of water droplets on the prior art hydrophobic surface show in FIG. 5A;

FIG. 6A is a side, cross-sectional view of a water droplet on an hydrophilic system in accordance with embodiments of the present invention; and

FIG. 6B is a side, cross-sectional view of a resulting water layer on the hydrophilic system shown in FIG. 6A.

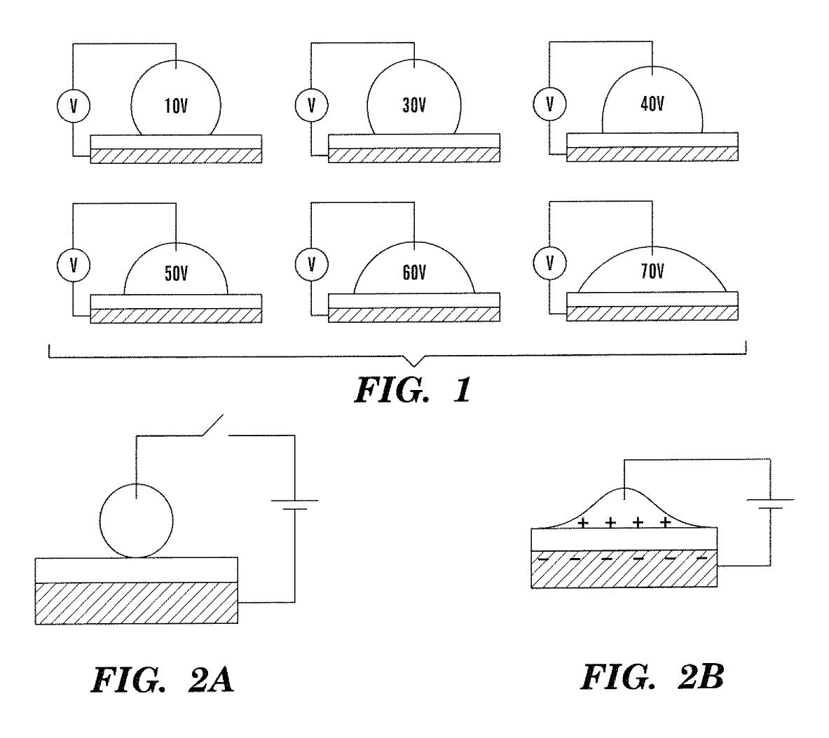

### DETAILED DESCRIPTION

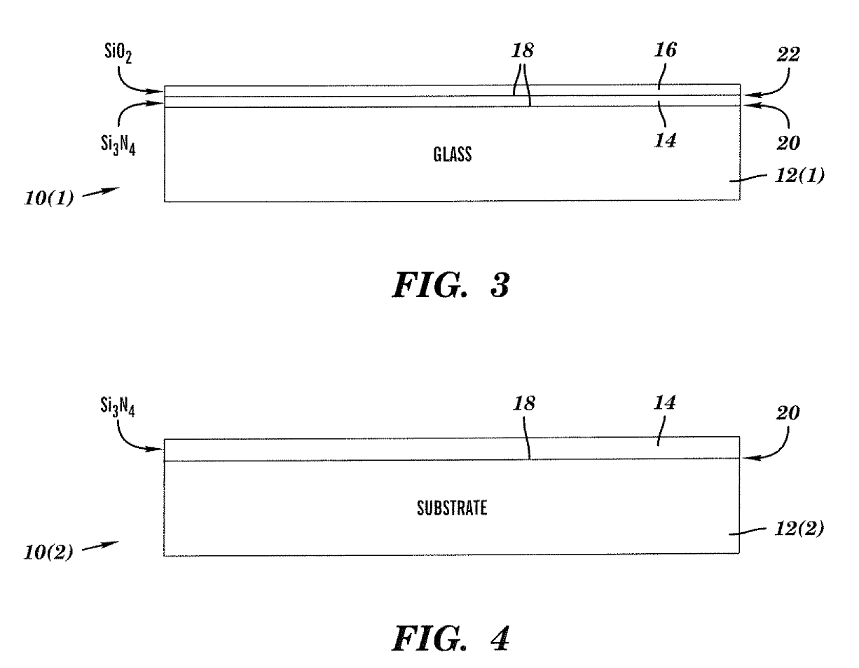

A hydrophilic system 10(1) in accordance with embodiments of the present invention is illustrated in FIG. 3. The hydrophilic system 10(1) includes a substrate 12(1), an insulating layer 14, another insulating layer 16, and a fixed static, monopole electrical charge 18, although the hydrophilic system can include other types and numbers of layers, elements, components, and systems in other configurations. The present invention provides a number of advantages including providing an effective and easy to implement hydrophilic system.

Referring more specifically to FIG. 3, the hydrophilic system 10(1) in accordance with embodiments of the present invention is illustrated. The hydrophilic system 10(1) has the substrate 12(1) which is selected because it is made of a substantially transparent material, although other types and numbers of materials can be selected because of other types of optical properties, such as being partially transparency or being substantially opaque and reflective like a mirror. By way of example only, applications for which a substrate 12(1) is selected because it is made of a substantially transparent material include face shields, goggles, visors, glasses, windshields, and windows by way of example only. Additionally and by way of example only, applications for which another substrate is selected because it is made of a partially transparent material include a welder's face mask which blocks at least a portion of the range of wavelengths comprising the visible, infrared, and ultraviolet spectrums, but is transparent or attenuated in other ranges. Further and by way of example only, applications for which yet another substrate 12(2) illustrated in FIG. 4 is selected because it is made of a substantially opaque and reflective material includes a mirror.

The hydrophilic system 10(1) also has the insulating layer 14 deposited on a surface of the substrate 12(1) and another insulating layer 16 deposited on a surface of the insulating layer 14, although other types and numbers of layers can be deposited. The insulating layer 14 is selected to be dissimilar from the insulating layer 16 to assist in the retention of the fixed and static monopole charge at one or more of the interfaces 20 and/or 22. In this particular embodiment, the insulating layer 14 comprises silicon nitride Si₃N₄ and the insulating layer 16 comprises silicon dioxide SiO₂, although other types of insulating materials can be used.

Additionally, in this particular embodiment, the insulating layers 14 and 16 are substantially transparent in the range of wavelengths in the visible spectrum and are selected because the insulating layers 14 and 16 operate without substantially interference of the substantially transparent optical property of the substrate 12(1), although the insulating layers 14 and 16 could have other levels of transparency, such as partially transparent with respect to a set range of wavelengths or opaque, and could be selected for other reasons.

Further, in this particular embodiment the insulating layers 14 and 16 have a thickness which is at least two or more orders of magnitude smaller than a thickness of the substrate 12(1), although the insulating layers 14 and 16 could have other ranges of thickness in comparison to the substrate 12(1). The substantially smaller thickness of the insulating layers 14 and 16 when compared to the thickness of the substrate 12(1) provides a number of advantages including helping to minimize any impact of the insulating layers 14 and 16 on the optical properties of the substrate 12(1) and also to minimize a consumer's ability to even detect the presence of the insulating layers 14 and 16.

A substantially fixed and static monopole electrical charge 18 is embedded at an interface 20 between the substrate 12(1) and the insulating layer 14 and at an interface 22 between the insulating layers 14 and 16, although the substantially fixed and static monopole electrical charge 18 could be embedded at other locations, such as just at interface 20 or just at interface 22 by way of example only. The embedded fixed and static electrical charge remains substantially at the interfaces 20 and 22 once embedded, although again the embedded fixed and static electrical charge could be embedded and remain at just one of the interfaces 20 or 22 or at other interface locations if there are additional insulating layers. The embedded fixed and static electrical charge is on the order of at least 1×10¹⁰ charges/cm² and is a negative electrical charge, although orders of magnitude and other types of charge could be embedded.

Referring more specifically to FIG. 4, another hydrophilic system 10(2) in accordance with other embodiments of the present invention is illustrated. The hydrophilic system 10(2) is the same in structure and operation as the hydrophilic system 10(1), except as described and illustrated herein. Elements in hydrophilic system 10(2) which are like those in hydrophilic system 10(1) will have similar reference numerals. In the hydrophilic system 10(2), the substrate 12(2) is selected because it is made of a substantially opaque and reflective material to form a mirror, although other types and numbers of materials can be selected because of other types of optical properties, such as being substantially or partially transparent. Additionally, the hydrophilic system 10(2) only has one insulating layer 14 as described above with the fixed and static electrical charge embedded at the interface 20.

A method of making a hydrophilic system 10(1) for use as an automobile windshield will now be described. First, a glass substrate 12(1) is selected because of one or more designated optical properties appropriate for an automobile windshield, such as being substantially transparent for wavelengths in the visible spectrum by way of example only, although the substrate could be selected based on other properties, such as those that produce tinted glass.

Next, a first insulating layer 14 made of silicon nitride and having a thickness ranging between about 50 nm to about 100 nm thick is selected because it will operate without substantially interference of the at least one designated optical property of the substrate 12(1), in this example substantial transparency, although other types of insulating layers could be used. The first insulating layer 14 is deposited on a surface of the substrate 12(1) forming an interface 20 between the first insulating layer 14 and the substrate 12(1).

Next, a second insulating layer 16 made of silicon dioxide and having a thickness ranging between about 50 nm to about 100 nm thick is selected because it will operate without substantially interference of the at least one designated optical property of the substrate 12(1), in this example substantial transparency, although other types of insulating layers which are dissimilar from insulating layer 14 could be used. The second insulating layer 16 is deposited on a surface of the first insulating layer 14 forming an interface 22 between the first insulating layer 14 and the second insulating layer 16.

Although two insulating layers 14 and 16 are shown, other numbers and types of layers may be used. Additionally, any suitable deposition technique can be used to deposit these layers including, but not limited to, Chemical Vapor Deposition (CVD), sputtering, evaporation, or any other deposition process. Optionally, to establish a resilient scratch and shatter resistant, anti-fogging material, this outermost insulating layer which is being deposited can be a hard, scratch resistant material. By way of example only, this outermost layer could be Si₃N₄, Al₂O₃, MgF₂, LiF, ZrO₂, CaF₂, Ta₂O₅, diamond or diamond like carbon, although other types of materials and other numbers of layers could be used to form this scratch and shatter resistant protection. The dissimilar insulating layers 14 and 16 also can be deposited on a polycarbonate substrate to add shatter resistance, although any other type of substrate suitable for the particular application could be used.

Next, the monopole electronic charge is injected into the interface 20 between the first insulating layer 14 and the substrate 12(1) and into the interface 22 between the first insulating layer 14 and the second insulating layer 16 by ballistic charge injection where the charge becomes substantially fixed and permanent, although again the fixed and static charge could be embedded in other numbers of interfaces, such as just interface 20 or just interface 22. Although ballistic charge injection is disclosed other manners for depositing the fixed, monopole charge at the interfaces 20 and 22 can be used. By way of example only, sacrificial conductive layers (not shown) could be disposed on opposing sides of the dissimilar insulating layer 16 and substrate 12(1) and subsequently an electric field is applied which is sufficient to inject electrons into the interfaces 20 and 22. In this example, a fixed and static monopole charge on the order of at least 1×10¹⁰ charges/cm² is stored at the interface, although other amounts of fixed and static monopole charge can be embedded.

A method of making a hydrophilic system 10(2) for use as a mirror is the same as the method of making a hydrophilic system 10(1), except as described herein. A substrate 12(2) is selected because of one or more designated optical properties appropriate for mirror, such as being substantially opaque and reflective for wavelengths in the visible spectrum by way of example only, although the substrate could be selected based on other properties.

Next, a first insulating layer 14 made of silicon nitride and having a thickness ranging between about 50 nm to about 100 nm thick is selected because it will operate without substantial interference of the at least one designated optical property of the substrate 12(2), in this example substantially opaque and reflective. The first insulating layer 14 is deposited on a surface of the substrate 12(2) forming an interface 20 between the first insulating layer 14 and the substrate 12(2).

In this particular embodiment there is no insulating layer 16 deposited and thus no interface 22 to embed fixed and static charge. Instead, the fixed and static charge is substantially embedded at the interface between the substrate 12(2) and insulating layer 14 in the manner described above for the method of making hydrophilic system 10(1).

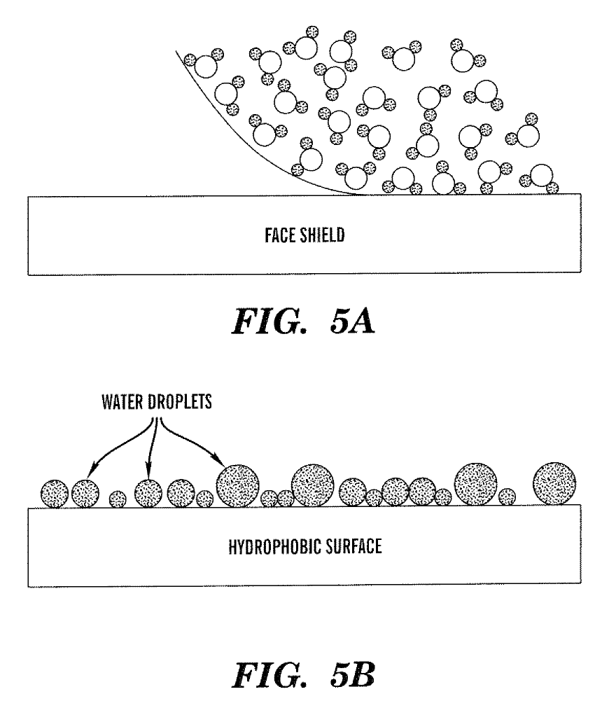

Next, the operation of water droplets on a prior art face shield without the present invention will be described and illustrate with reference to FIGS. 5A-5B. In this example, when a water droplet lands on a surface of the prior art face shield as shown in FIG. 5A, the surface tension of the water droplet exceeds the force require to interact with the surface of the face shield so the droplet substantially retains its shape. As the water droplets begin to accumulate as shown in FIG. 5B, the water droplet will interfere with the designated optical property of the face shield to transmit light without distortion or any other deleterious optical effects. In particular, the water droplets will scatter incoming light interfering with the vision of the operator wearing the face shield.

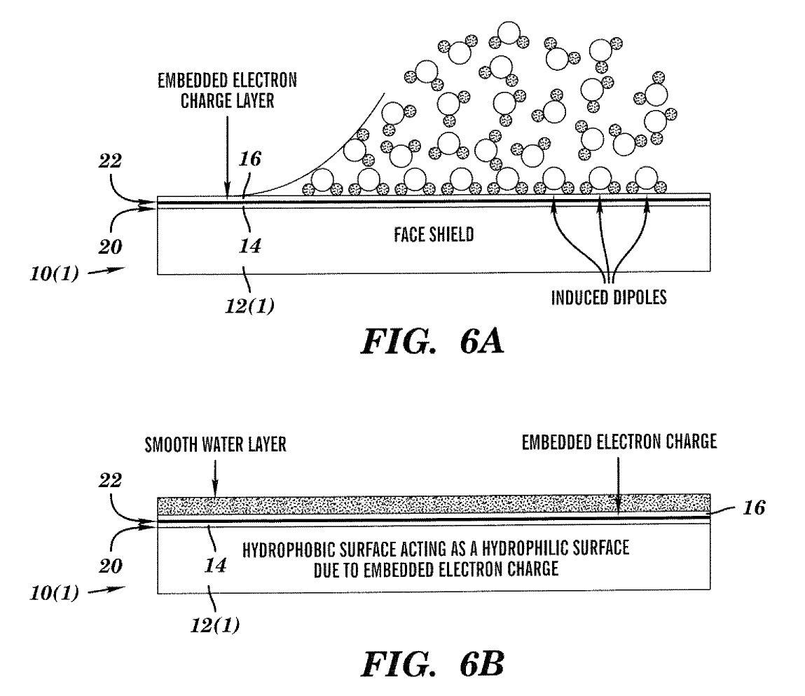

In sharp contrast, the operation of water droplets on a face shield which comprises hydrophilic system 10(1) in accordance with embodiments of the present invention will be described and illustrated with reference to FIGS. 6A-6B. In this example, when a water droplet lands on a surface of the face shield which comprises hydrophilic system 10(1) as shown in FIG. 6A, the surface tension of the water droplet does not exceed the force required to interact with the surface of the face shield so the droplet substantially loses its shape. In particular, the static, fixed, embedded electron charge located substantially at the interfaces 20 and 22 attracts the opposite sign charge of the water molecules, i.e. in the case of negative trapped monopole charge will attract the hydrogen side, although again the charge may be embedded at only one of the interfaces 20 and 22 and still operate in the same manner.

With this attraction and as the water droplets accumulate, the water droplets wet the surface of the face shield which comprises hydrophilic system 10(1), creating a smooth water film that does not substantially scattering light as shown in FIG. 6B. The attraction between the water molecules and the static, fixed, embedded electron charge occurs because water molecules are polar. The two hydrogen atoms are about 105 degrees apart, therefore the hydrogen side of the water molecule appears as positive charge and the oxygen side of the water molecule appears as negative charge with the attraction as shown in FIG. 6A. Accordingly, water droplets do not substantially interfere with the vision of the operator wearing the face shield comprising hydrophilic system 10(1), although other hydrophilic systems could have been used, such as hydrophilic system 10(2) if the substrate 12(2) is replaced with substrate 12(1) or another substrate which is substantially transparent.

Accordingly, as described and illustrated by the examples above, the establishment of a virtually perpetual, fixed, static, monopole embedded charge nano layer at an interface 22 between dissimilar insulating layers 14 and 16 and/or at an interface 20 between the substrate 12(1) or 12(2) and the insulating layer 14, the electric field from the embedded fixed and static charge overcomes the surface tension of any moisture on the outer insulating layer 14 or 16 and causes the moisture to form a continuous smooth moisture sheet. As a result, typically there are few, if any, droplets remaining on the outer insulating layer 14 or 16 that could reduce visibility due to light scattering. Additionally, the dissimilar insulators with the embedded electron charge at the interfaces have no noticeable effect on the optical properties of the substrate 12(1) or 12(2). Further, the one or more dissimilar insulating layers can be on other surfaces of the substrate, such as an inner surface.

As a result, the present invention provides systems and methods that easily and effectively convert a normally hydrophobic material into a hydrophilic material. Additionally, the present invention provides an effective hydrophilic system for a variety of different types of apparatuses, including face shields, windshields, goggles, glasses, etc. that is permanent and is unaffected by any wiping or other surface treatments.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A hydrophilic system comprising:
a substrate selected because of at least one designated optical property;
one or more dissimilar insulating layers which are one of on and adjacent to at least a portion of a surface of the substrate and which optically operate without substantial interference of the at least one designated optical property of the substrate; and
a substantially fixed and static monopole electrical charge embedded at an interface between at least one of the substrate and one of the one or more dissimilar insulating layers and two of the one or more dissimilar insulating layers.

2. The system as set forth in claim 1 wherein the at least one designated optical property of the substrate comprises substantially transparency with respect to at least one range of wavelengths.

3. The system as set forth in claim 2 wherein the range of wavelengths comprises the visible spectrum.

4. The system as set forth in claim 1 wherein the at least one designated optical property of the substrate comprises partial transparency with respect to at least one range of wavelengths.

5. The system as set forth in claim 4 wherein the range of wavelengths comprises the visible, infrared and ultraviolet spectrums.

6. The system as set forth in claim 1 wherein the at least one designated optical property of the substrate comprises being substantially opaque with respect to at least one range of wavelengths.

7. The system as set forth in claim 6 wherein the substrate is reflective of the range of wavelengths comprising the visible spectrum.

8. The system as set forth in claim 1 wherein the embedded fixed and static electrical charge is on the order of at least 1×10¹⁰ charges/cm².

9. The system as set forth in claim 1 wherein the at least one of the substrate and one of the one or more dissimilar insulating layers and two of the one or more dissimilar insulating layers comprise at least one layer made of a material from a group consisting of SiO₂, Si₃N₄, Al₂O₃, MgF₂, LiF, ZrO₂, CaF₂, Ta₂O₅, diamond or diamond like carbon and another layer made of a different material from the group consisting of SiO₂, Si₃N₄, Al₂O₃, MgF₂, LiF, ZrO₂, CaF₂, Ta₂O₅, diamond or diamond like carbon.

10. The system as set forth in claim 1 wherein the one or more dissimilar insulating layers further comprises two or more of the dissimilar insulating layers which are one of on and adjacent at least a portion of the surface of the substrate and which operate without substantial interference of the at least one designated optical property of the substrate.

11. A method of making a hydrophilic system, the method comprising:
selecting a substrate because of at least one designated optical property;
providing one or more dissimilar insulating layers which are one of on and adjacent to at least a portion of a surface of the substrate and which optically operate without substantial interference of the at least one designated optical property of the substrate; and
embedding a substantially fixed and static monopole electrical charge at an interface between at least one of the substrate and one of the one or more dissimilar insulating layers and two of the one or more dissimilar insulating layers.

12. The method as set forth in claim 11 wherein the at least one designated optical property of the substrate comprises substantially transparency with respect to at least one range of wavelengths.

13. The method as set forth in claim 12 wherein the range of wavelengths comprises the visible spectrum.

14. The method as set forth in claim 11 wherein the at least one designated optical property of the substrate comprises partial transparency with respect to at least one range of wavelengths.

15. The method as set forth in claim 14 wherein the range of wavelengths comprises the visible, infrared and ultraviolet spectrums.

16. The method as set forth in claim 11 wherein the at least one designated optical property of the substrate comprises being substantially opaque with respect to at least one range of wavelengths.

17. The method as set forth in claim 16 wherein the substrate is reflective of the range of wavelengths comprising the visible spectrum.

18. The method as set forth in claim 11 wherein the embedded fixed and static electrical charge is on the order of at least 1×10¹⁰ charges/cm².

19. The method as set forth in claim 1 wherein the at least one of the substrate and one of the one or more dissimilar insulating layers and two of the one or more dissimilar insulating layers comprise at least one layer made of a material from a group consisting of SiO₂, Si₃N₄, Al₂O₃, MgF₂, LiF, ZrO₂, CaF₂, Ta₂O₅, diamond or diamond like carbon and another layer made of a different material from the group consisting of SiO₂, Si₃N₄, Al₂O₃, MgF₂, LiF, ZrO₂, CaF₂, Ta₂O₅, diamond or diamond like carbon.

20. The method as set forth in claim 11 wherein the one or more dissimilar insulating layers further comprises providing two or more of the dissimilar insulating layers which are one of on and adjacent at least a portion of the surface of the substrate and which operate without substantial interference of the at least one designated optical property of the substrate.
